(19) United States
(12) Patent Application Publication
(10) Pub. No.: US 2005/0034341 A1
(43) Pub. Date: Feb. 17, 2005

(54) Floor posters

(75) Inventor: John F Leutton, Cheshire, (GB)

Correspondence Address: GARDNER GROFF, P.C.;PAPER MILL VILLAGE, BUILDING 23, 600 VILLAGE TRACE, SUITE 300, MARIETTA, GA, 30067, US

(73) Assignees: Sales Activation Solutions Group Limited; Sales Activation Solutuions Group Limited

(21) Appl. No.: 10/498,699

(22) PCT Filed: Dec. 9, 2002
(86) PCT No.: PCT/GB02/05558

(30) Foreign Application Priority Data
Dec. 10, 2001 (GB) 0129525.2

(51) Int. Cl. G09F 7/12

(52) U.S. Cl. 40/594

(57) ABSTRACT

A display system, particularly for external floors (18) comprises a sealant layer (20) which is absorbed into, and seals, a floor surface. A poster or banner is adhered to the sealed floor surface and comprises a layer of displayable material (14) and a transparent protective layer (12). An adhesive layer (16) which may be pre-applied to the reverse of the displayable material and protected by a peal off strip, adheres the banner to the sealed surface.

This invention relates to improvements in display posters, particularly, but not exclusively to posters located in hostile environments such as car park surfaces and/or exterior surfaces.

Presently, interior floors (for example, stone, concrete, asphalt or marble) are capable of having posters or notices applied to them. Such posters might display safety information or advertisements. The posters are made from a substrate printed with the information for display on the top surface and an adhesive applied to the underside. A coating on the top surface may be applied to improve the coefficient of friction of the poster to help reduce slippage.

Generally, floors need to be flat with a smooth surface to allow the adhesive to stick the poster to the floor with sufficient adhesion; a poster stuck to a rough floor surface may not last as long as one stuck to a smooth surface. Also, moisture can ingress between the floor and the poster causing the poster to become unstuck from the floor and lift from the floor.

Therefore, present floor posters are limited to application on areas of flooring where the environment is generally good and the poster is sheltered from rain, for example, inside a building. Such areas might include railway station forecourts or pedestrian alley-ways in covered shopping malls.

We have appreciated that present floor posters can not be applied to surfaces in hostile environments whilst remaining in a satisfactory state and without the need for continual replacement. However, we have appreciated that there is a need for such posters in hostile environment such as outdoor or indoor car parks. In this context, the term floor is used to mean an exterior surface such as a car park or road.

The present invention addresses this problem.

According to the invention, the present invention provides a display system comprising a poster for fixing to an external surface; the poster comprising a panel having a plurality of layers, including an adhesive layer for adhering the poster to the external surface; and a display layer with displayable content for viewing when the poster is fixed to the surface; the system further comprising a sealer, wherein the external surface is pre-treated with the sealer to form a moisture resistant boundary to which the poster is fixed.

The invention also provides a method for fixing a poster to an external surface, the poster comprising; a panel having a plurality of layers, including an adhesive layer for adhering the poster to the external surface; and a display layer with displayable content for viewing when the poster is fixed on the surface; the method comprising sealing the external surface with a sealer to form a moisture resistant boundary; and adhering the poster to the sealed surface.

The invention also provides a floor display system, comprising: a poster to be fixed to a surface, the poster including a display layer having displayable content for viewing when the poster is fixed to the surface; a sealant for sealing the surface to form a moisture resistant boundary; and an adhesive layer for adhering the poster to the sealed surface.

Embodiments of the invention have the advantage that a display system can be produced that can give acceptable performances in a hostile environment such as a car park. The use of a sealant on the underlying car park surface prior to an adhesive layer prevents the ingress of dirt and moisture under the poster to be displayed, greatly prolonging the life. The adhesive will bond to the sealant rather than the surface.

Preferably, the sealant penetrates into the surface, for example by 2-3 cms. This is particularly advantageous where the surface is uneven and porous.

Embodiments of the invention are also advantageous for certain indoor environments such as multi-storey car parks which are very hostile environments not suited to existing floor displays.

Embodiments of the invention will now be described by way of example with reference to the accompanying figures, in which:

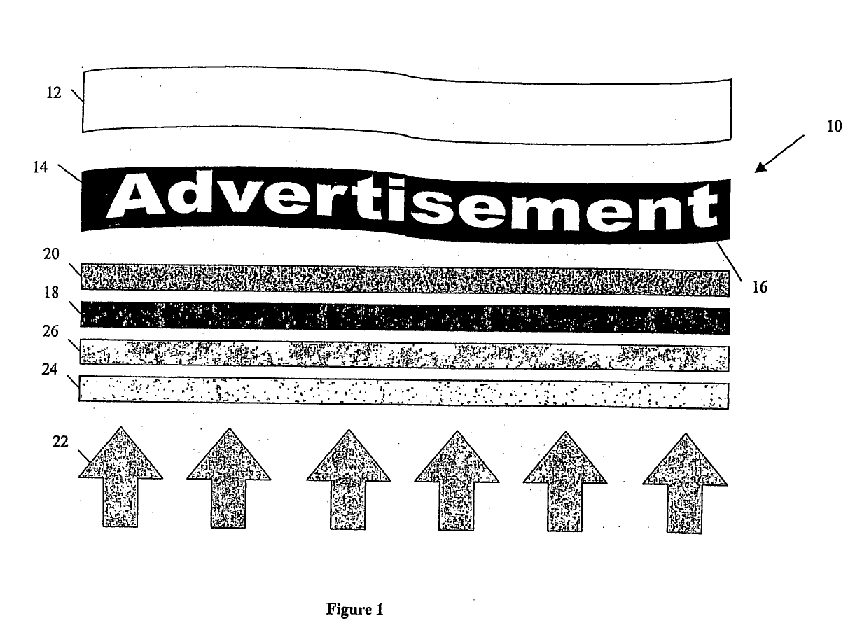

FIG. 1 is a schematic of a floor poster embodying the present invention;

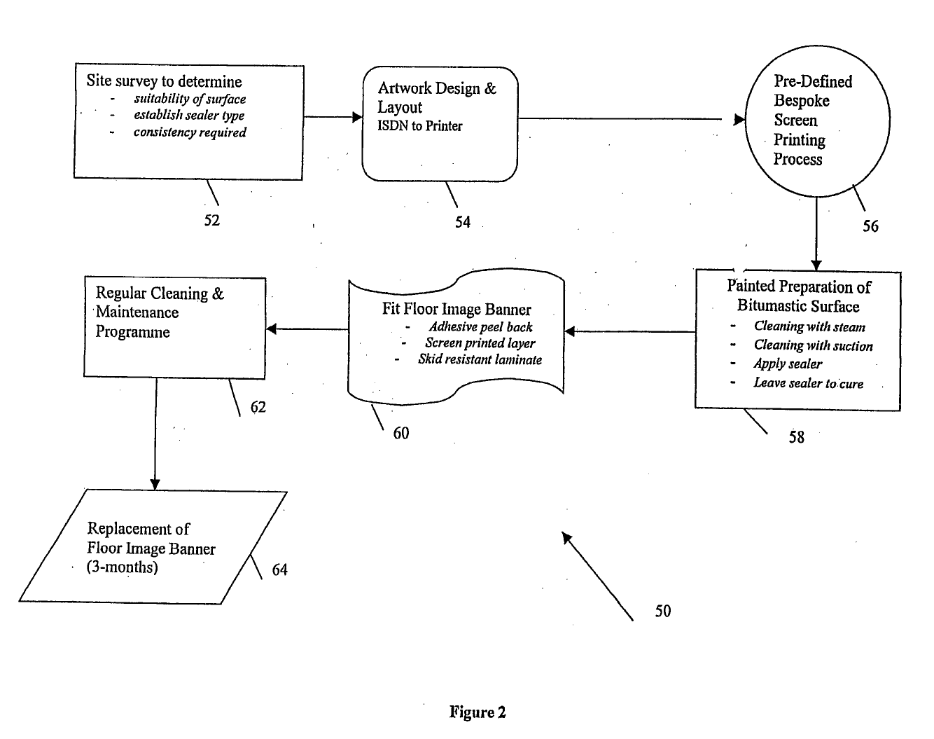

FIG. 2 is a flow diagram of a process embodying the present invention.

Referring to FIG. 1, a floor poster 10 comprises a panel with a number of laminated layers. The example illustrated has three layers, a protective layer 12, a printed layer 14, and an adhesive layer 16. The protective layer is preferably transparent thereby allowing the printed layer to be viewed, and prevent water from penetrating to the printed layer. Preferably, the protective layer also provides a surface of similar frictional characteristics to the surface of the floor on which the poster may be placed. This helps to prevent people or vehicles losing traction and slipping on the poster surface.

The asphalt floor on which the panel is to be placed comprises an upper asphalt layer 18 which overlies a layer of sand 26 which in turn overlies a drainage layer 24. The asphalt layer 18 is pre-treated with a sealer compound 20. The compound 20 seals the top layer of asphalt 18 from water or moisture 22 that may ingress or penetrate through the drainage layer 24 and sand 26 that underlie the asphalt 18; the sealer waterproofs the top layer of the floor.

The sealer compound is applied to the asphalt in liquid form and preferably penetrates into the asphalt preferably soaking approximately 2 to 3 cm in to the asphalt from the asphalt's surface. Due to differences in asphalt or other floor types depending on their usage, and subsequent differences in permeability to the sealer, different sealers are required for different asphalts or other floor surfaces. This generally requires that the surface to which the poster is to be applied is surveyed to assess which sealer compound is best suited for that asphalt type. A poster embodying the present invention may also be installed on other porous floors such as brick paving, concrete, tiles, tarmac (RTM), terrazzo, block paving, concrete paving stones or even marble surfaces.

The adhesive layer 16 comprises a solid adhesive coating on the back of the panel beneath the printed layer that is protected by a peal back coating of a type well known in the field (not shown). The peal back coating is pealed off to expose the adhesive just before the panel is stuck to the pre-treated area of floor. The panel is applied to the pre-treated surface in a way that reduces pockets of air getting trapped between the panel and the floor.

FIG. 1 shows water 22 ingressing through the asphalt from beneath the surface, through the underlying layers. If the poster is placed outside, or in an environment where the floor may be wet, then water could also ingress between the panel and the floor. The top protective layer 12 is chosen to provide a waterproof barrier to water trying to penetrate the poster through the top layer of the panel. Also, water is prevented from penetrating between the panel and the pre-treated asphalt, by the adhesive providing a good seal between the panel and the pre-treated asphalt.

It is estimated that the posters applied to asphalt using a compound or method embodying the present invention last for approximately three months under normal usage before renewal of the panel is required. The sealer is estimated to require renewal after a period of five years or so has lapsed.

The panel is worn by traffic passing over the poster; such traffic may take the form of persons or vehicles. If an inappropriate (or no) sealer is used to treat the asphalt before the panel is applied to the surface, then the poster is unlikely to remain in an acceptable state for an acceptable period. This is especially so if the panel is subjected to adverse weather conditions or excessive traffic wear. In such circumstances, the panel's adhesive will lose adhesion to the asphalt and lift off the asphalt. This may require the panel to be renewed at a rate that is considered not commercially acceptable.

By ‘acceptable state’ we mean a state in which the panel's printed layer is legible and all the panel remains adhered to the asphalt surface; there are no edges or areas of the panel that have come unstuck from the asphalt. By an ‘acceptable period’ we mean a period of approximately at least two months in which the panel requires little or no maintenance to keep it in an acceptable state.

Referring to FIG. 2, the process 50 for applying the poster to an area of floor is shown. The area on which the poster is to be placed is first surveyed at 52 to check for the suitability of the poster being applied to the surface, and also to determine which sealer is best suited for that particular area of floor. The survey determines the likelihood and rate at which the poster will be exposed to water or moisture. This includes a determination of the porous nature of the floor and the poster's proposed location. These factors should be taken into account when determining the type of sealer to be applied to the floors.

It may be possible to apply a sealer which is capable of sealing most exterior surfaces prior to applying the banner, in which case, the need to survey the surface may be redundant.

The appropriate artwork for the panel of the poster is designed at 54 and printed at 56. The floor surface is treated at 58 with the suitable sealer and the panel placed at 60 on the treated area. The panel may require regular cleaning and maintenance at 62 to keep it in a suitable condition, and replacement at 64 of the panel may be required after a three month period.

An example of a suitable sealant is a resin having the following composition:

| | |
|---|---|
| Methyl Methacrylate | 30%-60% |
| 1,1′(P-Tolyimino) Dipropane - 2- 02 | 0-1% |
| Butyl Methacrylate | 10%-30% |
| Ethylhexyl Acrylate | 10%-30% |

The relative percentages of each component will vary depending on the type of asphalt, or other surface to be sealed, including, but not limited to concrete and concrete brick paved surfaces. Suitable sealants are supplied by Floor Image International Ltd, of Stockport, United Kingdom under the trade mark SL SCRATCH COAT.

It is envisaged that posters embodying the present invention may be applied to car park areas or external walkways made of asphalt. The posters might, for example, be used to advertise shops or stores close to that particular parking area or to direct shoppers to an entrance of shopping malls from the car park. Such car park posters might have a width equivalent to 3 car parking spaces and with a depth of one metre, or so. Other sizes of posters/panels are possible but may be limited by the surface on which they are to be applied. The actual nature of the displayable material is not a feature of the present invention.

The placement of the posters in areas previously unutilised will provide an extra revenue stream for car park operators and others. Advertisers will also benefit by the opportunity to advertise their stores or services close to the point of sale.

Modifications to the embodiments described are possible within the scope of the invention. For example, the adhesive may be applied as a separate layer on top of the sealed surface, rather than as a layer prepared on the back of the layer of displayable material. Other modifications will occur to those skilled in the art.

The skilled person will be able to perceive of many different applications embodying the present invention, as well as modifications to the embodiments described. For example, high visibility signs could be placed on the pavement close to pedestrian closings to help the visually impaired identify the crossing; or to identify a route to safe position in case of emergency.

1. A display system, comprising:
a poster for fixing to an external surface, the poster comprising a panel having a plurality of layers, including an adhesive layer for adhering the poster to the external surface, and a display layer with displayable content for viewing when the poster is fixed to the surface; and
a sealer, wherein the external surface is pre-treated with the sealer to form a moisture resistant boundary to which the poster is fixed.

2. A display system as claimed in claim 1, wherein the panel further comprises a protective layer on top of the printed layer.

3. A display system as claimed in claim 2, wherein the protective layer has a coefficient of friction generally similar to, equal, or greater than the surface coefficient of friction.

4. A display system as claimed in claim 1, wherein the sealer penetrates a distance into the external surface.

5. A display system as claimed in claim 4, wherein the type of sealer used for the treatment of the surface is dependent on the type of surface.

6. A display system as claimed in claim 4, wherein the sealer penetrates between 2 cm and 3 cm into the surface.

7. A display system according to claim 1, wherein the sealant comprises 30-60% Methyl Methacrylate, 10-30% Butyl Methacrylate and 10-30% Ethylhexyl Acrylate.

8. A display system according to claim 7, wherein the sealant further comprises up to 1% 1, 1′ (P-Tolylimino) Dipropane-2-02.

9. A display system according to claim 5, wherein the surface is a floor.

10. A display surface according to claim 9, wherein the floor is porous.

11. A display system according to claim 9, wherein the floor surface comprises asphalt.

12. A display system according to claim 9, wherein the floor surface comprises concrete.

13. A display system according to claim 9, wherein the floor surface comprises brick.

14. A poster for use in the system of claim 1.

15. A method for fixing a poster to an external surface, the poster comprising a panel having a plurality of layers, including an adhesive layer for adhering the poster to the external surface, and a display layer with displayable content for viewing when the poster is fixed on the surface, the method comprising:
sealing the external surface with a sealer to form a moisture resistant boundary; and
adhering the poster to the sealed surface.

16. A method according to claim 15, comprising cleaning the external surface prior to sealing with the sealer.

17. A method according to claim 16, wherein the cleaning comprises removing dirt, oil and grease.

18. A method as claimed in claim 15, comprising conducting a survey of the surface for the determination of the sealer type to be used prior to sealing the surface.

19. A method according to claim 15, wherein the external surface is an external floor.

20. A method according to claim 15, wherein sealing the external surface comprises applying sealant to the surface to soak into the surface.

21. A poster fixed to an external surface by the method of claim 15.

22. A floor display system, comprising:
a poster to be fixed to a surface, the poster including a display layer having displayable content for viewing when the poster is fixed to the surface;
a sealant for sealing the surface to form a moisture resistant boundary; and
an adhesive layer for adhering the poster to the sealed surface.

23. A floor display system according to claim 22, wherein the poster includes the adhesive layer.

24. A floor display system according to claim 23, wherein the adhesive layer is protected by a peal off strip which is removable for application of the adhesive layer to the sealed surface.

25. A method for fixing a poster to a floor surface, comprising sealing the external surface with a sealer to form a moisture resistant boundary; and adhering the poster to the sealed surface.
